(19) United States
(12) Patent Application Publication
(10) Pub. No.: US 2004/0268116 A1
(43) Pub. Date: Dec. 30, 2004

(54) Fault tolerant recovery block with reduced flash footprint

(76) Inventors: Virender K. Vasisht, Olympia, WA (US); Palsamy Sakthikumar, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/609,764

(22) Filed: Jun. 30, 2003

(51) Int. Cl. G06F 1/24

(52) U.S. Cl. 713/100

(57) ABSTRACT

In one embodiment, the invention includes mapping a protected memory block containing a backup recovery block into a startup address space, booting a system from the remapped backup recovery block, copying the backup recovery block into a visible memory space, and protecting a version of the recovery block in a protected memory space.

### BACKGROUND

1. Field

The present invention pertains to the field of recovery blocks for microprocessor system startup and, in particular, to a protected recovery block that allows for startup in the event of complete system failure.

2. Related Art

Microprocessor-based systems typically rely on a boot block or startup code within a flash memory for start up. If the integrity or the validity of the boot block is impaired, the system may not be able to start or run. The BIOS (Basic Input/Output System), including the boot block, is typically exposed and visible to the long term run-time environment and therefore vulnerable to crashes, virus attacks or external manipulation.

In order to protect the boot block, some systems block out (lock down) the boot block and even the rest of the BIOS software from all other components of the system. However, this prevents the BIOS from being updated within the run-time environment. Corrections of errors, feature enhancement, and upgrades require replacing the flash or parts of the flash or replacing the motherboard to which the flash is soldered.

As an alternative, some systems provide two copies of the BIOS (rolling BIOS). With two copies, the system can switch to an alternate copy if one copy has become compromised. Both versions of the BIOS can easily and quickly be updated in the run-time environment. However this configuration also exposes both versions of the BIOS to the run-time environment. As a result, the integrity and reliability of the recovery block and the BIOS remains at risk. In addition, a rolling BIOS requires twice as much flash memory as a single BIOS copy, increasing memory cost.

### ESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIGS. 1A through 1D are block diagrams of flash memory parts according to one embodiment of the invention in a recovery block backup process in which the memory is shown in each of four different states.

FIGS. 2A through 2D are block diagrams of flash memory parts according to one embodiment of the invention in a recovery block restoration process in which the memory is shown in each of four different states.

FIGS. 3A and 3D are block diagrams of flash memory parts according to one embodiment of the invention in a recovery process in which the memory is shown in each of two different states.

FIG. 4A is a flow chart for BIOS start up according to one embodiment of the invention.

FIG. 4B is a flow chart for recovery block backup according to one embodiment of the invention.

FIG. 4C is a flow chart for recovery block restoration according to one embodiment of the invention.

FIG. 5 is a block diagram of a computer system suitable for implementing one embodiment of the invention.

### DETAILED DESCRIPTION

According to some embodiments of the invention, a fault tolerant protective recovery block mechanism allows a software driven system to be recovered in the case of an entire system flash corruption, even when this corruption extends all the way to the BIOS recovery block. In one embodiment, a backup copy of the BIOS recovery block is always maintained in an unmapped flash space. Because it is unmapped, the flash space is protected and can hold a protected recovery block. If the entire primary BIOS image is corrupted and even if the system is unable to do a recovery boot, a user or system manager can switch from the primary BIOS image to the alternate protected recovery block. Using this protected recovery block, the system can start up even after a complete failure of the normal flash memory. The remainder of the BIOS can be recovered, if necessary, after the recovery block is restored.

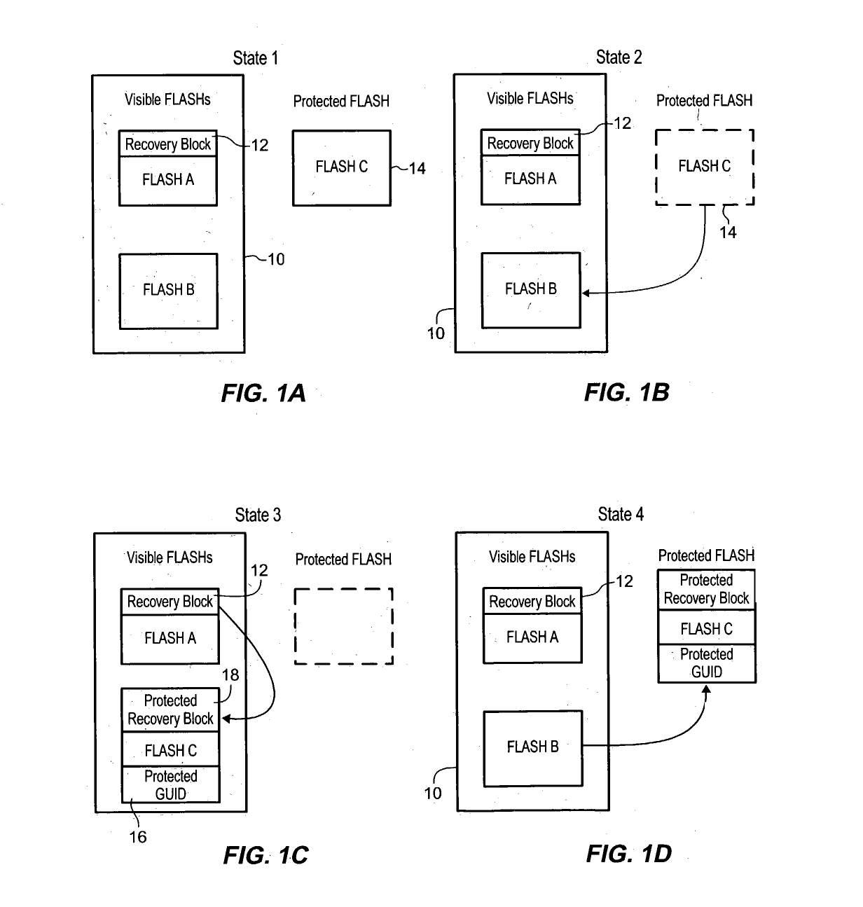

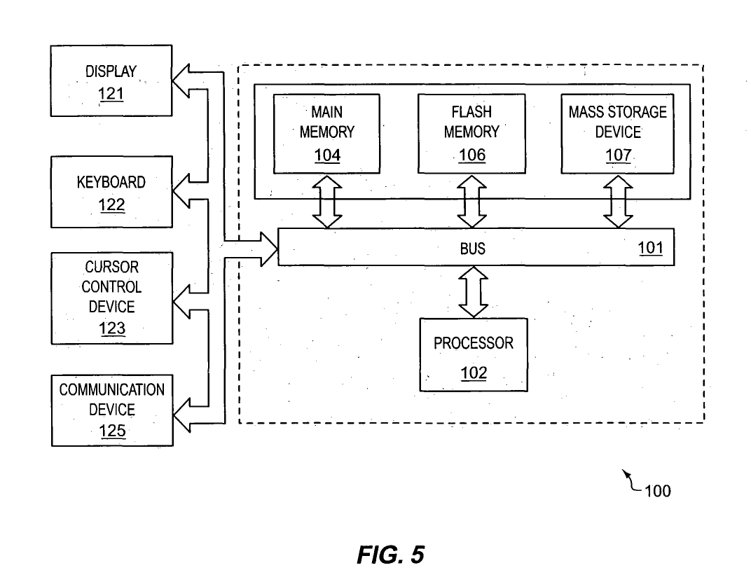

An example of one embodiment of the present invention is described in connection with FIGS. 1A through 1D. FIGS. 1A through 1D show block diagrams of memory components of a software-driven system. The memory components can be any type of non-volatile memory such as flash memory including PROM (Programmable Read Only Memory) and NVRAM (Non-Volatile Random Access Memory). While the memory can be attached to a motherboard of a microprocessor-based system, it can also be external and removable. Alternatively the memory can be on a magnetic medium or it can be a volatile memory that is sustained or restored between boots. The software-driven system can include a microprocessor or other logic unit that boots up using the recovery block and the BIOS. The system may also include a variety of different input, output and operations devices not shown. An example of one type of system appropriate for use with the present invention is described in connection with FIG. 5, below.

In FIG. 1A, there are at least two components to the flash memory used for booting the software-driven system. The main flash part 10 contains a primary BIOS image. The main flash part has two components, A and B. However, the particular number of components will depend on the application. The two components may be in the same or in different physical chips and they may be in the same or in different physical locations. One component, flash part A contains a recovery block 12. The recovery block can be a part of the total system BIOS or it can be a stand alone entity. The recovery block and the BIOS can be software, firmware or middleware. While the recovery block is shown associated with flash part A, it can be associated alternatively with flash part B or any of the other flash parts in the system.

There is also a protected memory 14 containing flash part C which may be in a separate chip or on the same chip as the main flash part. The protected flash part 14 is unmapped under normal boot circumstances and can contain the most current backup copy of the recovery block. It can also, or alternatively, store a special high reliability recovery block. Associated with these flash parts is a microprocessor (not shown) or other software driven logic device which uses the flash parts to boot up. The microprocessor can also use a mapping mechanism supported by an associated chip set. The mapping mechanism maps the hidden protected flash parts into visible or addressable space and allows read and write operations from the primary flash or other memory while the software is stored in the visible or addressable space. In one embodiment of the invention, the flash parts of FIG. 1A correspond to Intel Firmware Hub (FWH) parts, but any other type of flash parts can be used.

FIG. 1A shows an initialized system according to one embodiment of the invention in which flash parts A and B together contain a complete copy of the BIOS. A part of this BIOS is a recovery block 12, used by the system to recover from a corruption of the startup code or normal boot code. Flash parts A and B are the visible flash mapped into the startup procedure of the system. Flash parts A and B contain the software used by the system for booting up. The two parts are shown as an example. The BIOS may be contained in more or fewer flash parts and in more than two different locations. A separate protected flash part 14 contains flash part C which can store at least a portion of the same BIOS as flash part A but in a protected address space. This protected flash part can be used to store a backup copy of the recovery block.

The configuration of FIG. 1A shows flash part C as uninitialized. Flash part C can be initialized or updated as shown in FIGS. 1B, 1C and 1D. Even if flash part C has been initialized, in normal operation the system does not know the contents of flash part C since it is unmapped. When flash part C is used to store a backup copy of the recovery block, the backup copy is protected from the run-time environment and from malicious attacks from e.g. viruses and hackers.

As the system boots up from the main recovery block, it will reach a reliable boot stage. After a reliable boot has been confirmed, the backup recovery block can be safely initialized or updated. The backup updating can be performed as the result of an integrity or validity check or an upgrade status check or it can be done as a matter of course after the validity of the main recovery block 12 has been confirmed through a reliable boot stage. As shown in FIG. 1B, to upgrade the protected backup recovery block, protected flash C is mapped into a visible address space 10. The flash part B can be mapped into a protected area 14, or unmapped if there is insufficient address space available or it may be unaffected by the remapping of flash part C From a visible address space, as shown in FIG. 1C, the validated recovery block in flash part A can be written into appropriate address spaces in flash part C and an identifier such as a GUID (Global Universal Identification) can be added to an appropriate addressable space.

As shown in FIG. 1C, flash part C contains both a copy of the main recovery block 12 and a protected GUID 16. Other portions of the BIOS or other code can also be written into the flash part. After all of the desired code has successfully been written into flash part C and validated, flash part C can be remapped back into the protected address space as shown in FIG. 1D. The cycle shown in FIGS. 1A, 1B, 1C and 1D can be repeated each time the system reaches a reliable recovery boot stage.

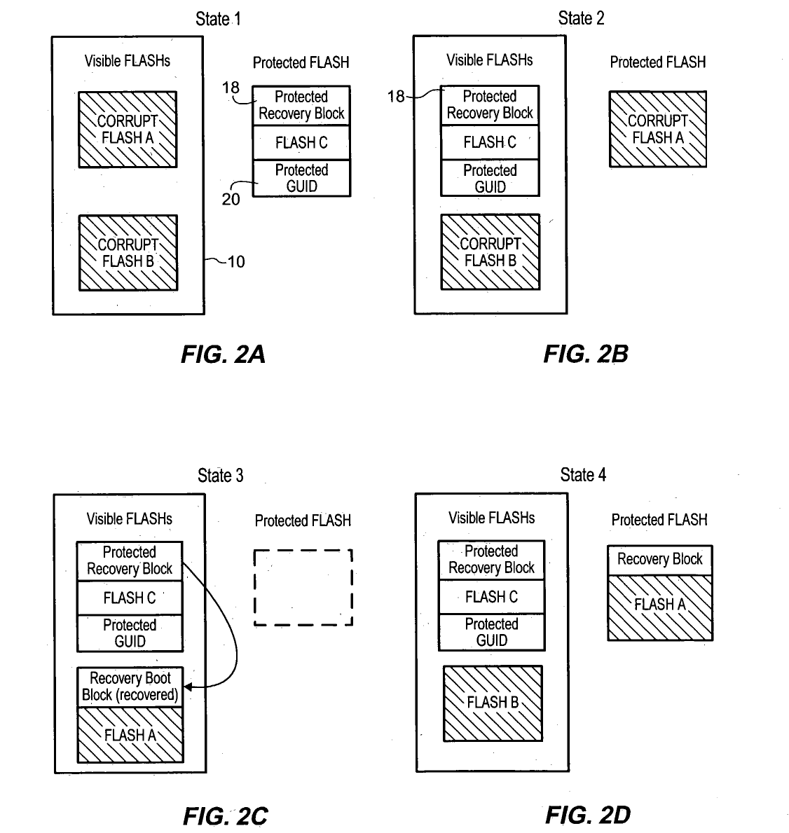

Once the protected backup recovery block is assured, it can be applied in the event of a complete system failure. FIG. 2A shows an example of such a failure. In the example embodiment shown in FIG. 2A, the main flash 10 containing flash A and flash B has been completely corrupted, however, the protected unmapped flash C, which contains a protected recovery block and a protected GUID remains intact. It is not necessary that all of flash parts A and B be completely corrupted or that only flash parts A and B be corrupted. Flash part C can be used whenever the system has trouble booting up. Flash part C can also contain other aspects of the start up code or BIOS, depending on how much space is available to dedicate to these functions. Flash part C remains intact because the unmapped, protected recovery block is not exposed to the run-time environment. In some embodiments flash part C can be implemented in non-volatile flash memory and is also protected from power losses and surges.

To recover from the state of FIG. 2A, the system can be switched to boot from flash part C instead of from flash part A. In many applications, the start up code contains fixed addresses for the recovery block and for many of the storage locations for the BIOS. In such systems, the startup process must somehow be changed to swap the fixed addresses from C to A. In one embodiment, hardware jumpers on the motherboard are switched to direct a microprocessor to boot up using flash part C instead of flash part A. Flash part C gets moved to the fixed startup addresses. In another embodiment, this startup code address change can be done remotely using commands. For example, IPMI (Intelligent Platform Management Interface, a server management solution of Intel Corp.) supported commands can be issued to an on board intelligent controller, such as a BMC (Baseboard Management Controller), to swap flash parts.

In one example, after flash parts A and B are corrupted or compromised, the system will be unable to boot. An error code will be generated or the system will be unable to generate any type of output. On realizing this, a user can switch the hardware jumpers, or a system administration controller can issue the appropriate commands to switch the flash parts. The switch will move the code at flash part C from its protected address space to a startup address space. Once the flash parts are swapped, this example system has a configuration such as that shown in FIG. 2B. In FIG. 2B, the system can boot from the protected recovery block in flash part C. Flash part B can be moved to an unmapped address space, as shown in FIG. 2B or it can be moved to a different mapped memory space. Flash parts A and B are still corrupted and not used. The system can now boot to a stable state using the formerly protected recovery boot block. The state to which the system can boot will depend upon how much startup code and BIOS is available from flash part C.

In FIG. 2C, after the system has recovered to a reliable recovery boot stage, the recovery boot block can be backed up. In one embodiment, the protected recovery block, in flash part C can be copied to the addressable memory space occupied by flash part A or to any other available writeable memory space. An image of the recovery boot block, once it has been written into an addressable space in flash part A, can then, as shown in FIG. 2D, be remapped into the protected space. Because of the switching or swapping of flash parts A and B, flash part A now contains a relatively protected copy of the recovery boot block in unmapped flash. At the condition shown in FIG. 2D, the system can provide an indication to the user that the system has recovered through the recovery boot process.

In order to simplify the software, the results of FIG. 2D can be achieved by performing the recovery backup process described above with respect to FIGS. 1A through 1D. In doing so, the entire contents of flash part C will unnecessarily be written into flash part A and tested. In addition, a GUID will also be written to flash part A. Neither of these events will seriously impact the use or availability of the protected recovery block. Alternatively, the system, on startup will detect the protected GUID in the mapped in recovery block and fetch a different instruction set for backing up the recovery block into flash part A.

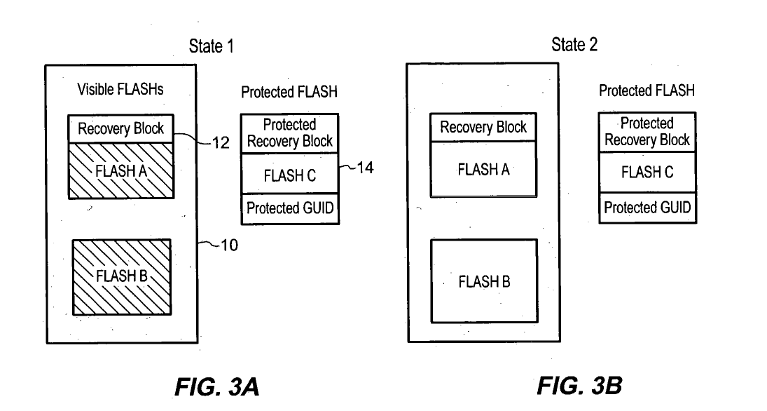

With the recovery block restored into flash part A, the user or a system BMC or any other control entity can again swap the addresses for flash part A and flash part C. As before, this can be done by switching hardware jumpers back to their original state or through IPMI commands, among other ways. The system is then in the configuration shown in FIG. 3A. In FIG. 3A, flash part C is back to its protected condition and includes the backup copy of the recovery block and the protected GUID in an unaltered, uncorrupted state. Flash part A in main flash 10 contains the copy of the recovery block which it obtained from flash part C. The remainder of the system is still corrupted.

From the condition of FIG. 3A, a normal full recovery can be run to restore all of the flash areas and any other software desired for system operation. The fully recovered system is shown in FIG. 3B. This configuration is similar to that of FIG. 1D. For recovery, it is not necessary that the entire system be corrupted as shown in FIG. 2A. If the recovery block is not corrupted, the system may be able to boot from the main recovery block, shown as residing in flash part A. A normal full recovery can then be used to restore the rest of the flash areas. However, if the recovery block is corrupted, as shown in FIG. 2A, then the process shown in FIGS. 2A through 2D can be used to make the system recoverable notwithstanding the corruption, of the recovery block.

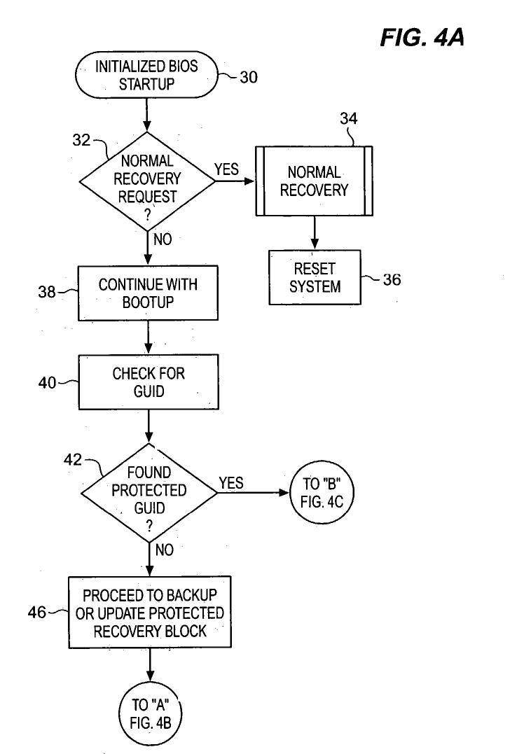

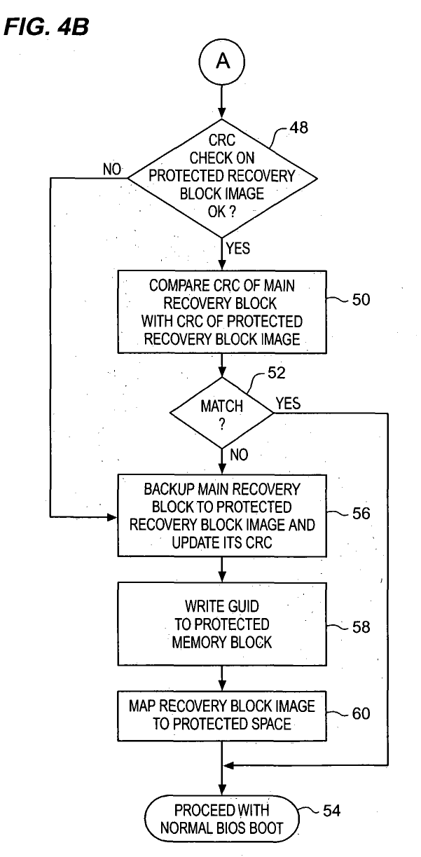

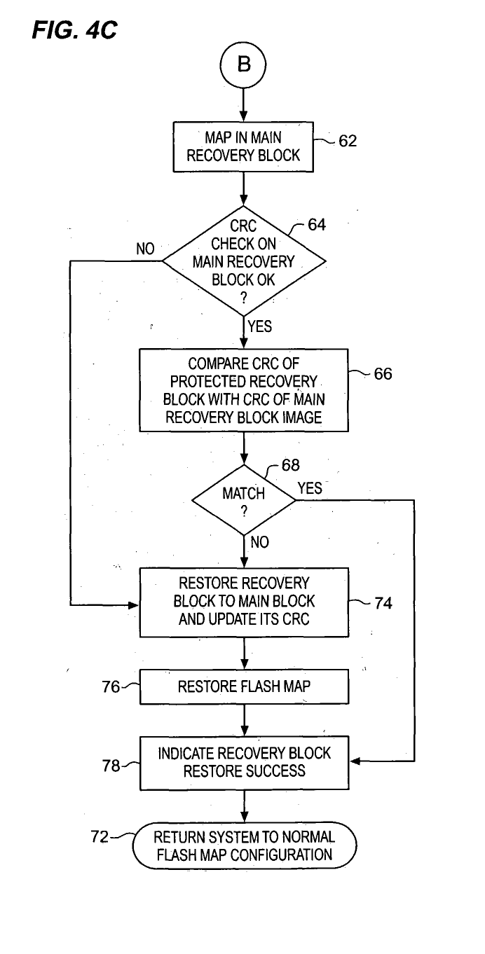

FIGS. 4A, 4B, and 4C show a flow chart detailing aspects of some embodiments of the invention described above. Referring first to FIG. 4A, in block 30 BIOS start up has been initialized and has reached the point in the execution of the BIOS code flow where the recovery conditions are checked and executed. This stage can be referred to as reliable recovery boot. At block 32, the recovery requests, if any, are evaluated. If there is a normal recovery request, then at block 34 a normal BIOS recovery is performed. In one embodiment, the recovery BIOS image is read from some external media and updated to the flash. The system is then reset in block 36. From that stage, the system can be rebooted. A normal recovery request in block 32 can be due to a PAL (Processor Abstraction Layer) request and flash authentication failures or it could be due to a hardware jumper switch made by a user.

If there is no normal recovery request then, at block 38, the boot up process continues. The recovery code can execute from memory or it can be shadowed so that the system can do read and write operations to the flash parts, as described above with respect to FIGS. 1C and 2C. Upon execution of the recovery code at block 38, at block 40 the system checks for the protected GUID. If the protected GUID is not found, then the system can assume that it is booting from the main flash and the backup recovery block is secure. If there is no protected GUID, then a backup operation of the recovery block can be performed. The backup operation is an optional process that can be used to ensure that the latest version of the recovery block is always safeguarded and available in a protected flash part.

The backup operation of the recovery block begins, as shown for example in FIG. 1B, by mapping in the protected recovery block into visible space at block 46. In an Intel Firmware Hub (FWH) Architecture, for example, the protected flash part can be mapped into an FWH by programming FWHSEL registers of the chipsets so that the hidden flash part becomes visible at the address space where ordinarily some other code may be stored.

Referring to FIG. 4B, at block 48, the CRC (Cyclic Redundancy Code) of the protected recovery block image is checked. This can be used to determine whether the protected recovery block is still valid. As an alternative, any other type of error detection or validation process can be used. Other types of error detection or correction codes include, parity codes, checksum codes, Hamming codes and Reed-Solomon codes, among others. If the check is okay then the CRC or other error code can be compared at block 50 with the CRC of the main recovery block in the visible part of the flash. This indicates whether the backup protected recovery block is the same version as the visible main recovery block. The versions of the main and backup recovery block can be compared in ways other than by comparing error detection codes for the two copies. For example, a version number, a time stamp, a bit length or any of a variety of other identifiers can be used.

If the CRC for the main recovery block and the backup recovery block match at block 52, then the normal BIOS boot can proceed at block 54. They system can conclude that the protected recovery block is up to date. On the other hand, if they do not match, then the backup recovery block can be updated at block 56. The main recovery block is written to the image of the protected recovery block and the CRC of this image is updated at block 56. A protected GUID signature is also written to the image of the protected memory block at block 58.

The entire code image can be written to the backup protected flash part and subsequently restored to protected status at block 60. For Intel Firmware Hub Architecture, the FWH map is restored by selecting back the prior FWH to its original location. The FWH contents which contain the backup recovery block image are then returned to the protected hidden status. Again, this can be performed using FWHSEL registers.

Refefring back to block 48 of FIG. 4B, if the CRC check is not okay then the backup recovery block is also updated using the visible recovery block with the process as described above with respect to blocks 56, 58 and 60. Accordingly, if the protected backup recovery block either is corrupted or invalid as determined by a CRC or other error check or if it is not current, then it can be backed up using the main recovery block image. Having backed up the backup recovery block and restored it to protected status, the normal BIOS boot continues at block 54.

Referring back to block 42 of FIG. 4A, if a protected GUID is found then the system can assume that the user has selected the protected recovery block for booting as an alternative. This can be done when the main flash parts A and B, as shown in FIG. 1A, are corrupted, as shown for example in FIG. 2A. As mentioned above, this selection of the alternate boot part can be done, for example, using hardware jumpers or remotely through IPMI commands to an on board Baseboard Management Controller (BMC), among other ways. At this stage, having found the protected GUID, the system knows that the main flash part has been swapped with the protected flash part. The start up process has proceeded to a reliable recovery boot state using the protected recovery block and now can proceed to backup the main recovery block based on the contents of the protected recovery block. This can be done using the same backup operation of the recovery block described above in connection with blocks 48-60.

Alternatively, using the Intel Firmware Hub flash parts or a similar system which allows flash parts to be remapped into visible and protected address spaces, a somewhat different process can be performed. The backup process of blocks 62-78 of FIG. 4C is described in the context of FWHSEL registers of an Intel Firmware Hub (FWH) flash part, however, the process can be readily adapted to other types of systems. At block 62, the main recovery block is copied into a visible address space, for example, the space formerly occupied by flash part B (see FIG. 2C). This can be done by first flushing a cache and then mapping the main flash part, formerly mapped into a protected area, into a visible area and swapping that main flash part for a third flash part, such as B, into an unmapped or protected area. This can be done by programming FWHSEL registers of the chipset.

With part A now visible, the recovery block in part A can be checked. In this way, if the recovery block is intact, then it can be maintained even if other aspects of FWH flash part A have been corrupted. At block 64, the recovery block in part A is checked. A CRC or other type of error check is performed. If the CRC check is not okay then the main recovery block in flash part A can be assumed to be corrupt. In this case, the recovery boot block from part C, which is the protected block from which the system booted, is copied to part A and the CRC is updated at block 74. At block 76, once a valid recovery boot block has been written into part A, the address map can be restored at block 76. In an FWH architecture, the FWHSEL register and the chipset are returned to the original configuration which is shown for example in FIG. 2D. In other embodiments, hardware jumpers are switched. At block 78, a recovery block restoration success can be indicated to the user.

Referring again to block 64, if the CRC does check out, then the CRC of the protected recovery block can be compared to that of the main recovery block at block 66. If these CRC's match at block 68, then at block 78 recovery block restoration success can be indicated. However, if they do not match, then at block 74 the recovery boot block can be restored from the protected recovery block at part C in block 74. The addressing map is then restored at 76 and a success is indicated at block 78. Once a successful recovery has been performed then the address mapping can be returned to the normal configuration at block 72. After the original map is restored, a fill recovery is performed. This can be done, for example, by swapping jumpers on the motherboard, as mentioned above, or by giving commands to the BMC to restore to the original state. The next time the system boots from the restored main memory part, the normal BIOS recovery can be performed to restore the complete BIOS image.

As can be seen from the description above, according to some embodiments of the present invention, at least one copy of the recovery block, capable of a reliable recovery boot, is always available even after the most catastrophic failure of the system such as power failures during a BIOS update or a BIOS attack, among other things. In addition, the system can be easily recovered even in a case of complete corruption of the BIOS or in conditions which require updates to the recovery boot block. A service technician can simply recover from the protected recovery block or from the update recovery block. It is not necessary to replace any flash chips or any boards since a recovery block is protected without isolating it from all read and write applications.

In addition, the backup recovery block is completely hidden from the run-time environment since the flash part having the recovery block is not mapped in under normal circumstances. If, as in some embodiments, the protected recovery block part is kept current by mirroring it on every successful boot, as described above with respect to FIGS. 1A, 1B, 1C and 1D, then the latest BIOS version can be maintained without replacing flash parts or boards.

In some embodiments, only the recovery block is duplicated in the protected flash part. As a result, the amount of additional memory required to store the protected recovery block can be much smaller than in a rolling BIOS system. In a powerful server implementation, the BIOS may require as much as 6 megabytes, however the recovery block may be as small as one megabyte. This presents a substantial savings in required memory space. For desktop and notebook applications the BIOS may be as much as two megabytes, whereas a recovery block can be limited to 128 kilobytes. As a result, the additional flash footprint used for the protected recovery block is kept small. These numbers for BIOS and recover block size are provided as examples. The present invention can reduce memory requirements regardless of the size of the BIOS and the recovery block.

FIG. 5 shows an example of a computer system 100 that can be used with some embodiments of the present invention. The computer system can be implemented as a server, workstation, desktop, tablet, or portable machine. It can also be implemented in one or more small portable platforms such as a notebook, a PDA (Personal Digital Assistant), or wireless web devices such as personal stereos, telephones and integrated messaging systems, and other devices. The computer system includes a bus or other communication means 101 for communicating information, and a processing means such as a microprocessor 102 coupled with the bus 101 for processing information.

The computer system can include a main memory 104, such as a random access memory (RAM) or other dynamic data storage device, coupled to the bus 101 for storing information and instructions to be executed by the processor 102. The main memory can also be used-for storing temporary variables or other intermediate information during execution of instructions by the processor.

The computer system also includes a nonvolatile flash memory 106, corresponding to the flash parts A, B and C described above. The flash memory is coupled to the bus for storing static information and instructions for the processor. A mass memory 107 such as a magnetic disk or optical disk and its corresponding drive can also be coupled to the bus of the computer system for storing information and instructions.

The computer system can also be coupled via the bus to a display device or monitor 121, such as a cathode ray tube (CRT) or Liquid Crystal Display (LCD), for displaying information to a user. For example, graphical or text messages, web clippings and other data may be presented to the user on the display device. Typically, an alphanumeric input device 122, such as a keyboard with alphanumeric, function and other keys, may be coupled to the bus for communicating information and command selections to the processor. A cursor control input device 123, such as a mouse, a trackball, cursor direction keys or stylus pad can be coupled to the bus for communicating direction information and command selections to the processor and to control cursor movement on the display 121. A microphone 124 and speaker 125 can also be connected to the bus for communications purposes or to play back any stored sounds.

One or more external communications interfaces 125 can also be coupled to the bus 101. These devices include, but are not limited to a modem, a network interface card, or other well known interface devices, such as those used for coupling to Ethernet, token ring, or other types of physical attachment for purposes of providing a communication link to support a local or wide area network (LAN or WAN), for example. The interfaces may be wired or wireless. In this manner, the computer system may also be coupled to a number of clients or servers via a conventional network infrastructure, including an intranet or the Internet, for example. The communications interface can be coupled to the computer system in any of a variety of ways including PCMCIA, MultiMedia, SDIO card, Compact PCI, ISA (Industry Standard Architecture), and an internal motherboard bus. The radio may also be a separate device, connected to the computer by cabling or similar electrical interface.

It is to be appreciated that a lesser or more equipped computer system than the example described above may be preferred for certain implementations. Therefore, the configuration of the computer system will vary from implementation to implementation depending upon numerous factors, such as price constraints, performance requirements, technological improvements, or other circumstances. Embodiments of the invention can also be applied to other types of software-driven systems that use different hardware architectures than that shown in FIG. 5.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention can include various steps. The steps of the present invention may be performed by hardware components, such as those shown in FIG. 5, or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMS, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps can be added to or deleted from any of the methods and components can be added or subtracted from any of the described apparatus without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

What is claimed is:

1. A method comprising:
booting a system from a main recovery block;
copying the main recovery block into a visible memory space;
mapping the copied main recovery block into a protected memory space.

2. The method of claim 1, further comprising mapping a protected recovery block into the visible memory space and checking the condition of the protected recovery block in the visible memory space and, if the protected recovery block is valid and current, not copying.

3. The method of claim 2, wherein checking comprises reading an error detection code for the protected recovery block and comparing it to an error detection code for the main recovery block.

4. The method of claim 1, further comprising mapping a protected recovery block into the visible memory space and copying the main recovery block over the protected recovery block in the visible memory space.

5. The method of claim 1, further comprising attaching an identifier to the copied main recovery block.

6. A machine-readable medium having stored thereon data representing instructions which, when executed by a machine, cause the machine to perform operations comprising comprising:
booting a system from a main recovery block;
copying the main recovery block into a visible memory space;
mapping the copied main recovery block into a protected memory space.

7. The medium of claim 6, further comprising instructions which, when executed by the machine, cause the machine to perform further operations comprising mapping a protected recovery block into the visible memory space and checking the condition of the protected recovery block in the visible memory space and, if the protected recovery block is valid and current, not copying.

8. The medium of claim 7, wherein the instructions for checking comprise instructions which, when executed by the machine, cause the machine to perform further operations comprising reading an error detection code for the protected recovery block and comparing it to an error detection code for the main recovery block.

9. The medium of claim 6, further comprising instructions which, when executed by the machine, cause the machine to perform further operations comprising mapping a protected recovery block into the visible memory space and copying the main recovery block over the protected recovery block in the visible memory space.

10. A method comprising:
mapping a protected memory block containing a backup recovery block into a startup address space;
booting a system from the remapped backup recovery block;
copying the backup recovery block into a visible memory space; and
protecting a version of the recovery block in a protected memory space.

11. The method of claim 10, wherein protecting comprises mapping the backup recovery block copy into a protected memory space.

12. The method of claim 111, wherein the protected memory space comprises an unmapped memory space.

13. The method of claim 10, wherein protecting comprises:
mapping the backup recovery block copy into a startup address space; and
mapping the backup recovery block into a protected memory space.

14. The method of claim 10, further comprising checking the condition of the copied backup recovery block in the visible memory space and mapping the backup recovery block copy into a protected memory space only if the copied backup recovery block is valid and current.

15. The method of claim 14, wherein checking comprises applying a validation code to determine whether there are errors in the copied backup recovery block.

16. The method of claim 10, wherein copying the backup recovery block copy into a backup memory space comprises copying the backup recovery block copy into a protected unmapped memory space.

17. The method of claim 10, further comprising booting the system from a version of the recovery block in a visible memory space.

18. A machine-readable medium having stored thereon data representing instructions which, when executed by a machine, cause the machine to perform operations comprising comprising:
mapping a protected memory block containing a backup recovery block into a startup address space;
booting a system from the remapped backup recovery block;
copying the backup recovery block into a visible memory space; and
protecting a version of the recovery block in a protected memory space.

19. The medium of claim 18, wherein the instructions for protecting comprise instructions which, when executed by the machine, cause the machine to perform further operations comprising:
mapping the backup recovery block copy into a startup address space; and
mapping the backup recovery block into a protected memory space.

20. The medium of claim 19, further comprising booting the system from the recovery block copy in a startup address space.

21. An apparatus comprising:
a visible memory part containing a recovery block and a basic input/output system; and
a protected memory part containing a copy of the recovery block of the visible memory part.

22. The apparatus of claim 21, wherein the visible memory part and the protected memory part are flash memory parts.

23. The apparatus of claim 21, wherein the visible memory part and the protected memory part are non-volatile.

24. The apparatus of claim 21, wherein the protected memory part is unmapped.

25. The apparatus of claim 21, wherein the visible memory part is mapped for start up using jumpers and wherein the protected memory part is not mapped.

26. The apparatus of claim 21, wherein the visible memory part comprises a boot block.

27. The apparatus of claim 21, wherein the protected memory part further contains an identifier to indicate that the copy of the recovery block is in the protected memory part.

28. A system comprising:
a microprocessor;
a bus coupled to the microprocessor;
a visible flash memory part coupled to the bus and mapped into a visible memory space, the visible memory part containing a recovery block and a basic input/output system; and
a protected flash memory part coupled to the bus and not mapped into a visible memory space, the protected memory part containing a copy of the recovery block of the visible memory part.

29. The system of claim 28, wherein the protected memory part is unmapped.

30. The system of claim 28, wherein the visible memory part is mapped for start up using jumpers and wherein the protected memory part is not mapped.

31. The system of claim 28, wherein the visible memory part comprises a boot block.

32. The system of claim 28, further comprising a controller and a set of selection registers, the controller setting the registers to determine how the visible and protected flash memory parts are mapped.
